(19) United States
(12) Patent Application Publication
(10) Pub. No.: US 2026/0166627 A1
(43) Pub. Date: Jun. 18, 2026

(54) METHOD AND FIXTURE FOR PLATING ELECTRICAL COMPONENTS

(71) Applicant: TE Connectivity Solutions GmbH, Schaffhausen (CH)

(72) Inventors: Benjamin A. DOPP, Harrisburg, PA (US); Yanzhe YANG, Hummelstown, PA (US)

(21) Appl. No.: 18/978,205

(22) Filed: Dec. 12, 2024

(51) Int. Cl. B22F 10/62; B22F 10/40; B33Y 10/00; B33Y 30/00; B33Y 40/20; C25D 7/00

(52) U.S. Cl. CPC B22F 10/62; B22F 10/40; B33Y 10/00; B33Y 30/00; B33Y 40/20; C25D 7/00

(57) ABSTRACT

A method for plating electrical components includes 3D printing a 3D printed element including a plating rack. The electrical components, and sacrificial spars are between the plating rack and the electrical components. The 3D printed element is a unitary, monolithic structure with the plating rack. The electrical components and the sacrificial spars are integral. The method positions the 3D printed element in a plating chamber. The method plates the 3D printed element in the plating chamber including plating the electrical components.

### BACKGROUND OF THE INVENTION

The subject matter herein relates generally to methods and fixtures for plating electrical contacts.

Electrical components are used in many applications. Typically, the electrical components are stamped and formed or machined contacts. Recently, there is a trend toward manufacturing electrical components by 3D printing the electrical components. For example, some applications utilize small electrical components or electrical components having a particular and complex geometry. It is desirable to plate the electrical components. Individually plating the electrical components is time consuming. It may be desirable to plate multiple contacts simultaneously to increase throughput. However, fixturing of the electrical components in a rack for plating can be difficult. For example, it may be a challenge to manually handle the parts during processing.

A need remains for improved methods and fixtures for plating electrical components.

### BRIEF DESCRIPTION OF THE INVENTION

In one embodiment, a method for plating electrical components is provided and includes 3D printing a 3D printed element including a plating rack. The electrical components, and sacrificial spars are between the plating rack and the electrical components. The 3D printed element is a unitary, monolithic structure with the plating rack. The electrical components and the sacrificial spars are integral. The method positions the 3D printed element in a plating chamber. The method plates the 3D printed element in the plating chamber including plating the electrical components.

In another embodiment, a plating fixture is provided and includes a 3D printed element including a 3D printed body including a plating rack, electrical components, and sacrificial spars between the plating rack and the electrical components. The 3D printed element is a unitary, monolithic structure with the plating rack. The electrical components and the sacrificial spars are integral. The plating rack includes rack walls including a first end wall, a second end wall, a first side wall between the first and second end walls, and a second side wall between the first and second end walls. The plating rack includes a cavity between the first and second end walls and the first and second side walls, at least one of the rack walls including a fixturing surface for locating the plating rack in a plating chamber. The sacrificial spars extend between the first and second side walls and the corresponding electrical components to support the electrical components in the cavity during plating. The electrical components are configured to be separated from the sacrificial spars post plating.

In a further embodiment, a 3D printing and plating system for forming electrical components is provided. The 3D printing and plating system includes a 3D printing station including a 3D printing device for forming a 3D printed element including a plating rack, electrical components, and sacrificial spars between the plating rack and the electrical components. The 3D printed element is a unitary, monolithic structure with the plating rack. The electrical components and the sacrificial spars are integral. The 3D printing and plating system includes a plating station including a plating chamber configured to receive the 3D printed element and plate the 3D printed element in the plating chamber including plating the plating rack, plating the sacrificial spars, and plating the electrical components.

### BRIEF DESCRIPTION OF THE DRAWINGS

FIG. 1 illustrates a 3D printing and plating system 10 for forming electrical components 110 in accordance with an exemplary embodiment.

FIG. 2 is a top perspective view of the 3D printed element 100 in accordance with an exemplary embodiment.

FIG. 3 is a bottom perspective view of the 3D printed element 100 in accordance with an exemplary embodiment.

FIG. 4 is a bottom perspective view of the 3D printed element in accordance with an exemplary embodiment showing some of the electrical components separated from the plating rack.

FIG. 5 is a cross sectional view of the 3D printed element 100 in accordance with an exemplary embodiment.

FIG. 6 illustrates a method for plating electrical components in accordance with an exemplary embodiment.

### DETAILED DESCRIPTION OF THE INVENTION

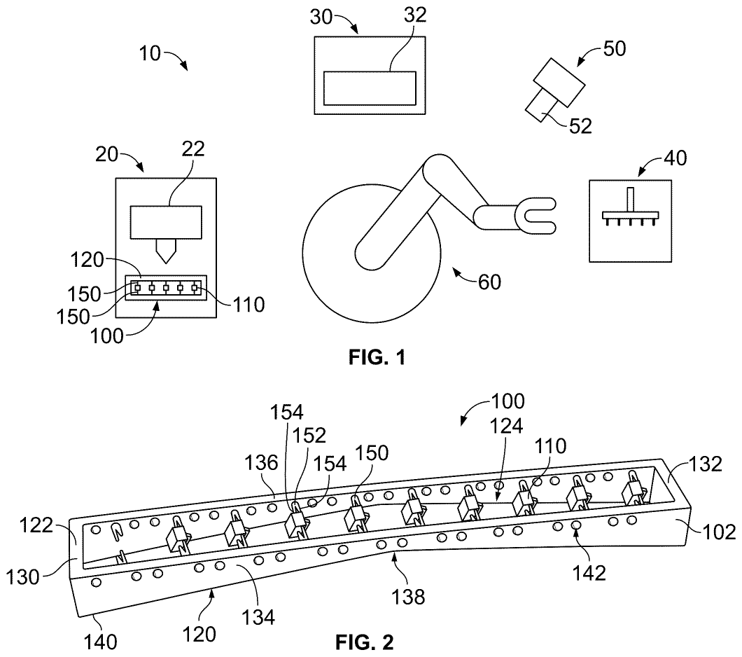

FIG. 1 illustrates a 3D printing and plating system 10 for forming electrical components 110 in accordance with an exemplary embodiment. The 3D printing and plating system 10 is configured to additive manufacture the electrical components 110 by a 3D printing process and is configured to plate the electrical components 110 by a plating process, such as an electroless plating process and/or an electroplating process. In an exemplary embodiment, the 3D printing and plating system 10 is configured to batch produce the electrical components 110, such as by co-forming a plurality of the electrical components 110 as part of a common 3D printed element and co-plating the plurality of the electrical components 110 during a common plating process. The electrical components 110 may be contacts, housings, backshells, connectors, or other types of electrical components.

The 3D printing and plating system 10 includes a 3D printing station 20 including a 3D printing device 22 for forming a 3D printed element 100. The 3D printing and plating system 10 includes a plating station 30 including a plating chamber 32 for plating the 3D printed element 100. The 3D printing and plating system 10 includes a separating station 40 including a part separator for separating the electrical components 110 from the 3D printed element 100. The 3D printing and plating system 10 may include other stations to perform other processes in alternative embodiments. The other stations may be located before, between, or after the 3D printing station 20 and/or the plating station 30 and/or the separating station 40. For example, the 3D printing and plating system 10 may include an imaging station 50 including a camera or other imaging device 52 for imaging the 3D printed element 100, such as for quality control. The 3D printing and plating system 10 may include a part manipulator 60 for moving the 3D printed element 100 (or components thereof) between the various stations. For example, the part manipulator 60 may include a multi-axis robot arm having a gripper or other end effector configured to move (for example, pick-and-place) the 3D printed element 100. The part manipulator 60 may include a conveyor or vibration tray for moving the parts.

The 3D printing device 22 may be an automated manufacturing machine, such as a 3D printing CNC machine, that controls the 3D printing process using a computer. The 3D printing device 22 may manufacture the 3D printed element 100 from various base materials, such as plastic, ceramic, glass, metal, or other base materials. For example, the base material may be stainless steel, aluminum, copper, or other metal base material. The base material may be a polylactic acid (PLA) material, a polyvinyl alcohol (PVA) material, a high impact polystyrene (HIPS) material, a polycarbonate (PC) material, a polypropylene (PP) material or other plastic material.

The 3D printing device 22 may be any of various types of 3D printing devices for forming the 3D printed element 100. For example, the 3D printing device 22 may be a stereolithography (SLA) device that uses a UV laser beam to expose photosensitive liquid resin to create 3D objects. The 3D printing device 22 may be a fused deposition modeling (FDM) device that uses a printer nozzle to deposit layers of melted and extruded thermoplastic filament to build parts. The 3D printing device 22 may be a selective laser sintering (SLS) device that uses a laser to solidify and bond layers of plastic, ceramic, glass, metal, or other materials. The 3D printing device 22 may be a digital light processing (DLP) device that uses lamps to produce prints faster than SLA printing because the layers dry quickly. The 3D printing device 22 may be a binder jetting device that can handle more than metal materials, including sand, ceramic, and full-color objects. The 3D printing device 22 may be an electron beam melting device that builds solid objects by melting powdered material. The 3D printing device 22 may be a polyjet device that uses photopolymers, UV light, and inkjet heads to quickly create precise parts. The 3D printing device 22 may be a 3D bioprinting device designed to print liquid or gel, and to handle sensitive material that contains living cells. Other types of 3D printing devices may be used in alternative embodiments.

In various embodiments, the 3D printing device 22 may include a laser or electron beam head for melting base material particles. In other various embodiments, the 3D printing device 22 may include an extruder configured to feed the base material filament, maintain the correct temperature, and push the filament through a heated nozzle. The extruder may have a heating element, drive gear, and nozzle. The 3D printing device 22 may include a print bed. The 3D printing device 22 may include a controller, such as a control circuit board, stepper motors, and frame.

In an exemplary embodiment, the 3D printed element 100 includes a plating rack 120 used to hold a plurality of the electrical components 110. For example, the electrical components 110 are held by sacrificial spars 150 between the plating rack 120 and the electrical components 110. In an exemplary embodiment, the 3D printed element 100 is a unitary, monolithic structure with the plating rack 120, the electrical components 110 and the sacrificial spars 150 being integral. For example, all of the electrical components 110 and the corresponding sacrificial spars 150 are co-formed with the plating rack 120 during a common 3D printing process such that the 3D printed element 100 can be handled and processed as a unit (for example, at the plating station 20). During processing, the 3D printed element 100 is configured to be loaded into the plating chamber 32 of the plating station 30 to plate the entire 3D printed element 100, including plating the plating rack 120, plating the sacrificial spars 150, and plating the electrical components 110. The entire 3D printed element 100 may be plated simultaneously, such as during a common plating process. The plated electrical components 110 may be separated from the plating rack 120 by breaking away the electrical components 110 at the sacrificial spars 150.

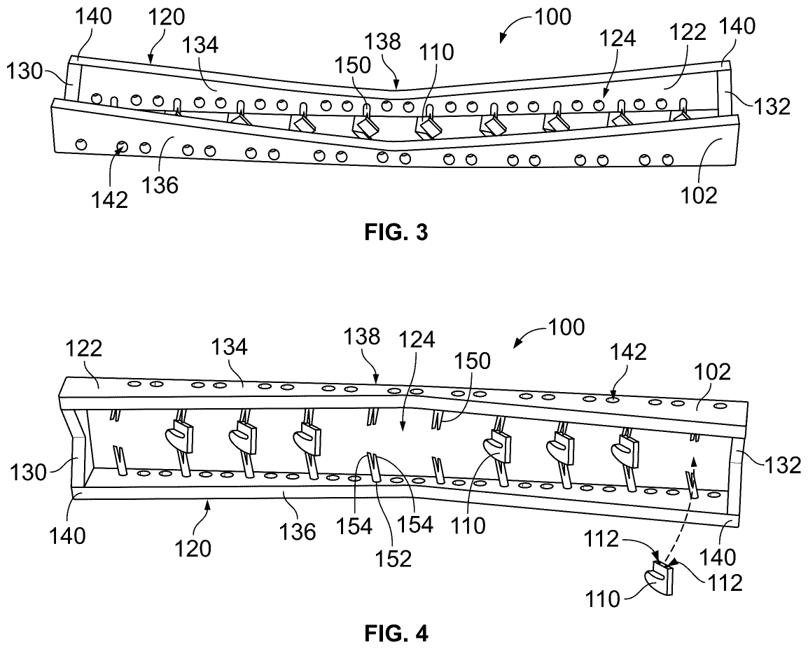

FIG. 2 is a top perspective view of the 3D printed element 100 in accordance with an exemplary embodiment. FIG. 3 is a bottom perspective view of the 3D printed element 100 in accordance with an exemplary embodiment. FIG. 4 is a bottom perspective view of the 3D printed element 100 in accordance with an exemplary embodiment showing some of the electrical components 110 separated from the plating rack 120.

The 3D printed element 100 includes the plating rack 120, the sacrificial spars 150 and the electrical components 110. The plating rack 120 holds a plurality of the electrical components 110. The 3D printed element 100 is formed as a unitary, monolithic structure. The electrical components 110 and the sacrificial spars 150 are integral with the plating rack 120. All of the electrical components 110 are co-formed with the corresponding sacrificial spars 150 during a common 3D printing process. The sacrificial spars are co-formed with the plating rack 120 during a common 3D printing process. In an exemplary embodiment, the 3D printed element 100 includes a 3D printed body 102. The 3D printed body 102 forms the underlying substrate of the plating rack 120, the sacrificial spars 150 and the electrical components 110. The 3D printed body 102 is formed by the 3D printing process. In an exemplary embodiment, the 3D printed body 102 is a dielectric material. In alternative embodiments, the 3D printed body 102 is a metal material.

During processing, the 3D printed element 100 is configured to be loaded into the plating chamber 32 of the plating station 30 as a single unit/structure without the need for individually, manually loading the electrical components 110 into holding frame. The entire 3D printed element 100 may be plated, such as plating the plating rack 120, plating the sacrificial spars 150, and plating the electrical components 110. The entire 3D printed element 100 may be plated during a common plating process. In an exemplary embodiment, the 3D printed element 100 may be plated with one or more layers. For example, the 3D printed element 100 may be plated with a base electroless plating layer and/or may be plated with one or more layers electroplating layers. The layers may be nickel plating layer(s), zinc plating layer(s), copper plating layer(s), or other metal plating layers.

Post-plating, the plated electrical components 110 may be separated from the plating rack 120 by breaking away the electrical components 110 at the sacrificial spars 150. For example, the plated electrical components 110 may be twisted to break away from the sacrificial spars 150.

In an exemplary embodiment, the plating rack 120 includes rack walls 122 forming a cavity 124. The sacrificial spars 150 and the electrical components 110 are located in the cavity 124. In an exemplary embodiment, the plating rack 120 is generally rectangular shaped. However, the plating rack 120 may have other shapes in alternative embodiments. In an exemplary embodiment, the rack walls 122 include a first end wall 130, a second end wall 132, a first side wall 134 between the first and second end walls 130, 132, and a second side wall 136 between the first and second end walls 130, 132. The cavity 124 is defined between the first and second end walls 130, 132 and the first and second side walls 134, 136.

In an exemplary embodiment, the first and second end walls 130, 132 are planar and parallel to each other. In an exemplary embodiment, the first and second side walls 134, 136 are planar and parallel to each other. The rack walls 122 may be in other orientations in alternative embodiments. Additional rack walls 122 may be provided in other alternative embodiments. In an exemplary embodiment, the first and second end walls 130, 132 may have variable heights, such as having the top edge and/or the bottom edge non-linear and/or non-parallel to each other. In an exemplary embodiment, the first and second side walls 134, 136 may have variable heights, such as having the top edge and/or the bottom edge non-linear and/or non-parallel to each other. For example, the first and second side walls 134, 136 may be taller/wider at the ends 130, 132 and shorter/narrower at central regions 138 thereof. Having the side walls 134, 136 wider at some portions may increase the rigidity and/or strength of the plating rack 120. Having the side walls 134, 136 narrower at some portions may decrease the weight and amount of material, and thus overall cost, of the plating rack 120.

In an exemplary embodiment, at least one of the rack walls 122 includes a fixturing surface 140 for locating the plating rack 120 in the plating chamber 32. The fixturing surface 140 may be planar to rest on a locating surface of the plating chamber 32 to locate the plating rack 120 in the plating chamber 32. The fixturing surface 140 may include slots, grooves, tabs, protrusions, or other locating elements defining the fixturing surface 140 to locate the plating rack 120 in the plating chamber 32. The fixturing surface(s) 140 may be located at the first end wall 130 and/or the second end wall 132. The fixturing surface(s) 140 may be located at the first side wall 134 and/or the second side wall 136.

In an exemplary embodiment, at least one of the rack walls 122 includes one or more openings 142 therethrough. For example, the first and second side walls 134, 136 may include openings 142 along the length of the side walls 134, 136. The openings 142 may receive electroplating wires (not shown) used for electroplating the 3D printed element 100. For example, the electroplating wires may pass through the openings 142. The openings 142 may be used for an electroless plating process and allows direct plating without needing a drilled hole in the part for attachment. In the illustrated embodiment, the openings 142 are located between the sacrificial spars 150 and the electrical components 110. Optionally, multiple openings 142 may be located between each of the sacrificial spars 150 and the electrical components 110, such as a pair of the openings 142. Greater or fewer openings 142 may be provided in alternative embodiments. The openings 142 may additionally or alternatively be located in the first and second end walls 130, 132.

The sacrificial spars 150 extend between the first and second side walls 134, 136 and the corresponding electrical components 110 to support the electrical components 110 in the cavity 124, such as for plating. The electrical components 110 are configured to be separated from the sacrificial spars 150 post plating. After separation, small unplated spots 112 (FIG. 4) are left behind on the electrical components 110 at connecting locations with the sacrificial spars 150. The size and location of the unplated spots 112 correspond to the size of the distal ends of the sacrificial spars 150. The size and location of the unplated spots 112 may be small enough to not have an effect on the electrical characteristics of the electrical components 110. For example, the unplated spots 112 may be positioned at a location along the electrical components 110 to not affect operation or use of the electrical components 110 (for example, located remote from the mating or terminating areas of the electrical components 110).

In an exemplary embodiment, each sacrificial spar 150 includes a base 152 and a tip 154 at a distal end of the sacrificial spar 150. The base 152 is located at the plating rack 120. The tip 154 is located at the corresponding electrical component 110. In an exemplary embodiment, the base 152 is wider than the tip 154. Optionally, the sacrificial spar may be bifurcated or forked to include multiple tips 154. For example, in the illustrated embodiment, each sacrificial spar 150 includes a pair of the tips 154. The tips 154 are connected to the corresponding electrical component 110 at spaced apart locations. Having multiple tips 154 provides greater support for the electrical component 110, such as by supporting the electrical component 110 at opposite ends of the electrical component 110. Having multiple tips 154 allows reducing the size (for example, cross-sectional area) of the connecting area with the electrical component 110, thus reducing the size of the unplated spots 112. The reduced size of the connecting area makes separation easier, such as making the break-away or twist off easier.

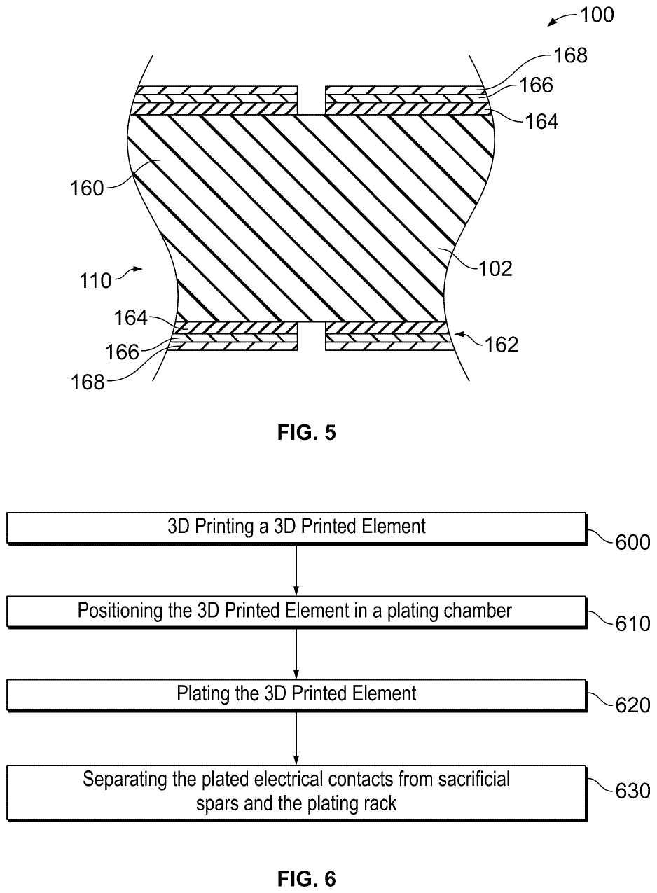

FIG. 5 is a cross sectional view of the 3D printed element 100 in accordance with an exemplary embodiment. For example, FIG. 5 shows the electrical component 110 portion of the 3D printed element 100; however, the sacrificial spars 150 and the plating rack 120 may have a similar cross-section (for example, materials and layers).

The 3D printed element 100 includes a substrate 160 defined by the 3D printed body 102. The substrate 160 may be a dielectric material, such as a polylactic acid (PLA) material, a polyvinyl alcohol (PVA) material, a high impact polystyrene (HIPS) material, a polycarbonate (PC) material, a polypropylene (PP) material or other plastic material. The substrate 160 may be a metal material, such as stainless steel, aluminum, copper, or other metal base material.

The 3D printed element 100 includes one or more plating layers 162 on the substrate 160. The plating on the 3D printed element 100 is to reduce contact resistance, ensuring efficient current flow for the electrical component 110. In the illustrated embodiment, the 3D printed element 100 includes a base electroless plating layer 164, a first electroplating layer 166, and a second electroplating layer 168. The electroless plating layer 164 may be a nickel or nickel-alloy layer. In other embodiments, the electroless plating layer 164 may be a copper or copper-alloy layer. Other materials may be used for the electroless plating layer 164. The first electroplating layer 166 may be a nickel plating layer, a silver plating layer, a zinc plating layer, a copper plating layer, or other metal plating layers. The second electroplating layer 168 may be a gold plating layer, a nickel plating layer, a silver plating layer, a zinc plating layer, a copper plating layer, or other metal plating layers. Other plating layers may be applied exterior to the second plating layer 168. The choice of plating material depends on the desired properties like conductivity, corrosion resistance, wear resistance, and application requirements.

FIG. 6 illustrates a method for plating electrical components in accordance with an exemplary embodiment. At 600, the method includes 3D printing a 3D printed element. The 3D printing may include 3D printing a plating rack, electrical components, and sacrificial spars between the plating rack and the electrical components to form a unitary, monolithic structure with the plating rack, the electrical components and the sacrificial spars being integral with each other.

The 3D printing may include forming each sacrificial spar with a base and a tip with the base located at the plating rack and the tip located at the corresponding electrical component. The base may be printed to be wider than the tip. The sacrificial spar may be printed with a pair of tips extending from each base, which connected to the corresponding electrical component at spaced apart locations. For example, the distal end of the sacrificial spar may be bifurcated or forked.

The 3D printing of the 3D printed element may include printing with a dielectric material. The 3D printing of the 3D printed element may include printing with a metal material.

The 3D printing of the 3D printed element may include forming the plating rack with rack walls including a first end wall, a second end wall, a first side wall between the first and second end walls, and a second side wall between the first and second end walls to form a cavity between the first and second end walls and the first and second side walls, the sacrificial spars extending between the first and second side walls in the corresponding electrical components to support the electrical components in the cavity. The 3D printing the 3D printed element may include forming openings in the first and second side walls. The forming of the plating rack may include forming the first and second side walls wider at the first and second ends and narrower at central regions of the first and second side walls.

At 610, the method includes positioning the 3D printed element in a plating chamber. For example, the plating rack may be set on one or more locating elements in the plating chamber to locate the 3D printed element in the plating chamber. The plating rack holds the electrical components at predetermined positions for plating. Because the electrical components are formed integral with the sacrificial spars and the plating rack during the co-forming process (for example, 3D printing), the 3D printed element may be handled and positioned in the plating chamber as a unitary structure.

At 620, the method includes plating the 3D printed element in the plating chamber. The plating may include plating the plating rack, plating the sacrificial spars, and plating the electrical components. In various embodiments, the plating includes electroless plating a base layer on the plating rack, on the sacrificial spars, and on the electrical components. In various embodiments, the plating includes electroplating one or more plating layers on the plating rack, on the sacrificial spars, and on the electrical components.

At 630, the method includes separating the plated electrical components from the sacrificial spars and the plating rack. In an exemplary embodiment, separating the plated electrical components includes twisting the electrical components to break the electrical components from the sacrificial spars. Separating the plated electrical components may include leaving small unplated spots on the electrical components at connecting locations with the sacrificial spars. For example, when the sacrificial spars are connected, small areas of the electrical components are covered and unable to be plated. The location of the sacrificial spars may be designed to position the unplated spots in areas that do not affect the function of the electrical components.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means - plus-function format and are not intended to be interpreted based on 35 U.S.C. § 112(f), unless and until such claim limitations expressly use the phrase “means for” followed by a statement of function void of further structure.

What is claimed is:

1. A method for plating electrical components comprising:
3D printing a 3D printed element including a plating rack, the electrical components, and sacrificial spars between the plating rack and the electrical components, wherein the 3D printed element is a unitary, monolithic structure with the plating rack, the electrical components and the sacrificial spars being integral;
positioning the 3D printed element in a plating chamber; and
plating the 3D printed element in the plating chamber including plating the electrical components.

2. The method of claim 1, further comprising separating the plated electrical components from the sacrificial spars and the plating rack.

3. The method of claim 2, wherein said separating the plated electrical components includes twisting the electrical components to break the electrical components from the sacrificial spars.

4. The method of claim 2, wherein said separating the plated electrical components includes leaving small unplated spots on the electrical components at connecting locations with the sacrificial spars.

5. The method of claim 1, wherein said 3D printing the 3D printing elements includes forming each sacrificial spar with a base and a tip, the base located at the plating rack, the tip located at the corresponding electrical component, the base being wider than the tip.

6. The method of claim 1, wherein said 3D printing the 3D printed element includes forming each sacrificial spar with a base and a pair of tips connected to the corresponding electrical component at spaced apart locations.

7. The method of claim 1, wherein said 3D printing the 3D printed element includes printing with a dielectric material.

8. The method of claim 1, wherein said 3D printing the 3D printed element includes printing with a metal material.

9. The method of claim 1, wherein said plating includes electroless plating a base layer on the plating rack, on the sacrificial spars, and on the electrical components.

10. The method of claim 1, wherein said plating includes electroplating one or more plating layers on the plating rack, on the sacrificial spars, and on the electrical components.

11. The method of claim 1, wherein said 3D printing the 3D printed element includes forming the plating rack with rack walls including a first end wall, a second end wall, a first side wall between the first and second end walls, and a second side wall between the first and second end walls to form a cavity between the first and second end walls and the first and second side walls, the sacrificial spars extending between the first and second side walls in the corresponding electrical components to support the electrical components in the cavity.

12. The method of claim 11, wherein said 3D printing the 3D printed element includes forming openings in the first and second side walls, said plating the 3D printed element includes connecting electroplating wires to the plating rack at the openings.

13. A plating fixture comprising:
a 3D printed element including a 3D printed body including a plating rack, electrical components, and sacrificial spars between the plating rack and the electrical components, wherein the 3D printed element is a unitary, monolithic structure with the plating rack, the electrical components and the sacrificial spars being integral;
the plating rack including rack walls including a first end wall, a second end wall, a first side wall between the first and second end walls, and a second side wall between the first and second end walls, the plating rack including a cavity between the first and second end walls and the first and second side walls, at least one of the rack walls including a fixturing surface for locating the plating rack in a plating chamber;
the sacrificial spars extending between the first and second side walls and the corresponding electrical components to support the electrical components in the cavity during plating;
wherein the electrical components are configured to be separated from the sacrificial spars post plating.

14. The plating fixture of claim 13, further comprising small unplated spots on the electrical components at connecting locations with the sacrificial spars after the electrical components are separated from the sacrificial spars.

15. The plating fixture of claim 13, wherein each sacrificial spar includes a base and a tip, the base located at the plating rack, the tip located at the corresponding electrical component, the base being wider than the tip.

16. The plating fixture of claim 13, wherein each sacrificial spar includes a base and a pair of tips connected to the corresponding electrical component at spaced apart locations.

17. The plating fixture of claim 13, wherein the 3D printed element includes a base plating layer electroless plated on the plating rack, on the sacrificial spars, and on the electrical components.

18. The plating fixture of claim 13, wherein the 3D printed element includes one or more plating layers electroplated on the plating rack, on the sacrificial spars, and on the electrical components.

19. The plating fixture of claim 13, wherein the rack walls include openings formed in the first and second side configured to receive electroplating wires.

20. A 3D printing and plating system for forming electrical components, the 3D printing and plating system comprising:
a 3D printing station including a 3D printing device for forming a 3D printed element including a plating rack, electrical components, and sacrificial spars between the plating rack and the electrical components, wherein the 3D printed element is a unitary, monolithic structure with the plating rack, the electrical components and the sacrificial spars being integral; and
a plating station including a plating chamber configured to receive the 3D printed element and plate the 3D printed element in the plating chamber including plating the plating rack, plating the sacrificial spars, and plating the electrical components.

21. The 3D printing and plating system of claim 20, further comprising a separating station configured to separate the electrical components from the sacrificial spars.
